(19) United States
(12) Patent Application Publication
(10) Pub. No.: US 2024/0273608 A1
(43) Pub. Date: Aug. 15, 2024

(54) MONITORING SUPPORT SYSTEM AND INFORMATION PROCESSING METHOD

(71) Applicant: Toshiba Tec Kabushiki Kaisha, Tokyo (JP)

(72) Inventor: Shiori HIDAKA, Fujisawa Kanagawa (JP)

(21) Appl. No.: 18/530,947

(22) Filed: Dec. 6, 2023

(30) Foreign Application Priority Data
Feb. 9, 2023 (JP) 2023-018686

(51) Int. Cl. G06Q 30/0601; G06Q 20/20; G06Q 20/40; G06V 20/52

(52) U.S. Cl. CPC G06Q 30/0633; G06Q 20/208; G06Q 20/405; G06Q 30/0641; G06V 20/52

(57) ABSTRACT

According to an embodiment, a monitoring support system determines whether or not a specified product accepted by a registration terminal is a predetermined product that needs to be checked. The monitoring support system acquires, where the specified product is the predetermined product that needs to be checked, an image taken by a camera from the camera at predetermined timing relative to timing at which the product that needs to be checked was registered as the transaction product by the registration terminal.

### CROSS-REFERENCE TO RELATED APPLICATIONS

This application is based upon and claims the benefit of priority from the prior Japanese Patent Application No. 2023-18686, filed on Feb. 9, 2023, the entire contents of which are incorporated herein by reference.

### FIELD

An embodiment to be described here generally relates to a monitoring support system and an information processing method.

### BACKGROUND

A transaction processing system in which a product that is a target of a transaction (hereinafter, referred to as a transaction product) is registered by a terminal operation of a customer in a sales floor of a store is known as a system for a shopping cart or the like having a function of registering a product, which includes a tablet terminal or the like. As a sales form of products to be processed for a transaction in such a transaction processing system, a product that combines a plurality of products that can also be sold individually as single-item products into one package (hereinafter, referred to as a packaged bundle) is sold. Examples thereof include a six can pack of canned beer.

A product code as a packaged bundle is generally displayed on the package of the packaged bundle for bundling the plurality of single-item products. When registering the packaged bundle as a transaction product, the product code as a packaged bundle should be input. However, a product code as a single-item product is often separately displayed on each of the single-item products included in the packaged bundle, and the product code is exposed outside the package for bundling the plurality of single-item products in many cases. For this reason, when registering a packaged bundle as a transaction product, there has been a possibility that a product code of a single-item product is erroneously input. Under such circumstances, it has been desired to take measures to correct erroneous specification in the case where a product different from a product taken out from a sales floor by a customer is specified as a transaction product.

### BRIEF DESCRIPTION OF THE DRAWINGS

FIG. 1 is a block diagram showing a schematic configuration of a transaction processing system according to an embodiment.

FIG. 2 is a block diagram showing a main circuit configuration of a transaction processing apparatus according to the embodiment.

FIG. 3 is a diagram showing a configuration of one data record included in a product master database according to the embodiment.

FIG. 4 is a diagram showing a configuration of transaction data according to the embodiment.

FIG. 5 is a block diagram showing a main circuit configuration of an attendant terminal according to the embodiment.

FIG. 6 is a block diagram showing a main circuit configuration of a cart terminal according to the embodiment.

FIG. 7 is a perspective view showing an example of how the cart terminal according to the embodiment is installed.

FIG. 8 is a flowchart showing cart processing according to the embodiment.

FIG. 9 is a flowchart showing the cart processing according to the embodiment.

FIG. 10 is a flowchart showing transaction processing according to the embodiment.

FIG. 11 is a flowchart showing the transaction processing according to the embodiment.

FIG. 12 is a diagram showing an example of a registration screen according to the embodiment.

FIG. 13 is a flowchart showing attendant support processing according to the embodiment.

FIG. 14 is a diagram showing an example of an attendant screen according to the embodiment.

FIG. 15 is a diagram showing a display example of an instant checking window according to the embodiment.

FIG. 16 is a diagram showing an example of a checking informing window according to the embodiment.

FIG. 17 is a diagram showing an example of a sales clerk operation window according to the embodiment.

FIG. 18 is a diagram showing an example of a rechecking window according to the embodiment.

### DETAILED DESCRIPTION

According to an embodiment, a monitoring support system includes: a registration terminal; a camera; a management terminal; and a processor. The registration terminal accepts specification of a product by a customer's operation and registers the specified product as a transaction product. The camera images an inside of the container that houses the product that is registered by the registration terminal. The management terminal displays the image taken by the camera. The processor is configured to determine whether or not the specified product accepted by the registration terminal is a predetermined product that needs to be checked. The processor is further configured to acquire, where the specified product is the predetermined product that needs to be checked, the image taken by the camera at predetermined timing relative to timing at which the product that needs to be checked was registered as the transaction product by the registration terminal. The processor is further configured to display the acquired image on the management terminal.

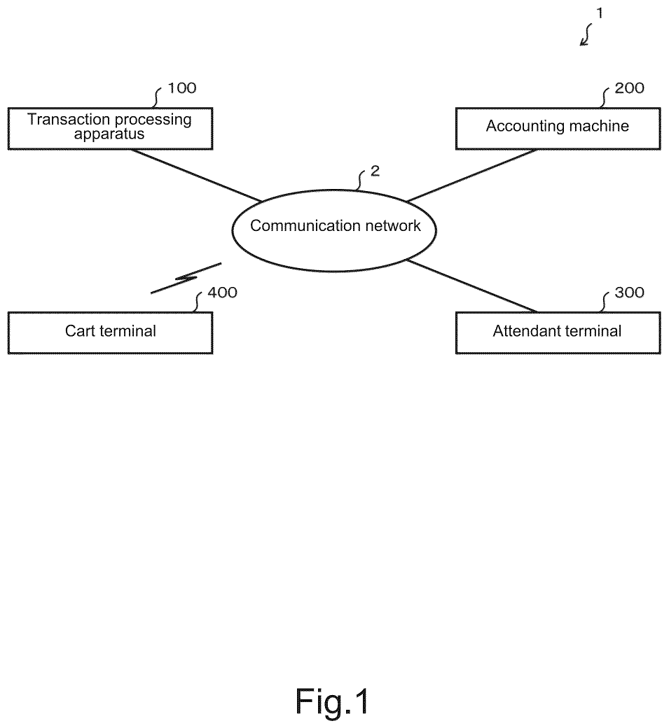

An example of an embodiment will be described below with reference to the drawings. Note that in this embodiment, a transaction processing system having a function as a monitoring support system will be described. In the drawings, the same reference symbols denote the same or similar portions. FIG. 1 is a block diagram showing a schematic configuration of a transaction processing system 1 according to this embodiment.

The transaction processing system 1 includes a transaction processing apparatus 100, an accounting machine 200, an attendant terminal 300, and a cart terminal 400. These apparatuses are capable of communicating with each other via a communication network 2. As the communication network 2, the Internet, a virtual private network (VPN), a local area network (LAN), a public communication network, a mobile communication network, and the like can be used alone or in combination as appropriate. As an example, the Internet and a mobile communication network are used on combination as the communication network 2. Note that although arbitrary numbers of the transaction processing apparatus 100, the accounting machine 200, the attendant terminal 300, and the cart terminal 400 may be included in the transaction processing system 1, ones of these apparatuses are shown in FIG. 1.

In the transaction processing apparatus 100, the accounting machine 200 and the cart terminal 400 are used as user interface terminal. Specifically, the accounting machine 200 and the cart terminal 400 are operated in a store by a customer of the store. The transaction processing apparatus 100 is an information processing apparatus that performs information processing for providing transaction processing service that processes a sales transaction between the customer and the store in accordance with the customer's operation. The transaction processing apparatus 100 is realized as, for example, a cloud server, and provides transaction processing service in a plurality of stores. The transaction processing apparatus 100 may be realized as, for example, a local server, and provide transaction processing service in only one store.

The accounting machine 200 is installed in a store and executes account processing relating to accounting of a transaction to be processed by the transaction processing apparatus 100. The accounting machine 200 receives an operator's operation in account processing. The operator of the accounting machine 200 is mainly a customer. A sales clerk is an operator of the accounting machine 200 in some cases.

The attendant terminal 300 is an information processing terminal to be operated by a sales clerk who plays the role of an attendant. The attendant terminal 300 is a terminal apparatus for a user interface relating to information processing for supporting work of a sales clerk relating to a transaction to be processed by the transaction processing system 1. The work of a sales clerk is, for example, work for monitoring the status of the transaction being processed and supporting a customer as appropriate. The attendant terminal 300 is an example of a management terminal.

The cart terminal 400 is an information processing terminal to be installed in a shopping cart (hereinafter, referred to as a cart) provided in a store. The cart terminal 400 is lent to a customer together with the cart. The cart terminal 400 is a terminal apparatus that receives a customer's operation for transaction processing by the transaction processing apparatus 100. The cart terminal 400 may include an information communication terminal that is lent to a customer from a store and carried and used by the customer. One of the operations for transaction processing by a customer is an operation for specifying a product to be registered as a transaction product as described below. In this way, the cart terminal 400 is an example of a registration terminal. Further, as an example of a registration terminal, an information communication terminal such as a smartphone, which is owned by the customer himself/herself and carried and used by the customer, may be used.

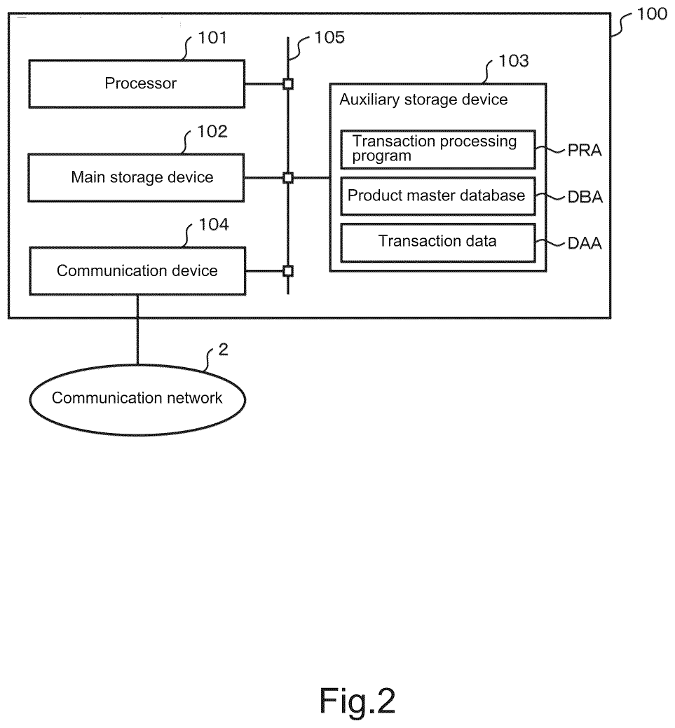

FIG. 2 is a block diagram showing a main circuit configuration of the transaction processing apparatus 100. The transaction processing apparatus 100 includes a processor 101, a main storage device 102, an auxiliary storage device 103, a communication device 104, a transmission path 105, and the like. The processor 101, the main storage device 102, the auxiliary storage device 103, and the communication device 104 are capable of communicating with each other via the transmission path 105.

By connecting the processor 101, the main storage device 102, and the auxiliary storage device 103 to each other via the transmission path 105, a computer that performs information processing for controlling the transaction processing apparatus 100 is configured. The processor 101 corresponds to the central part of the computer. The processor 101 executes information processing for controlling the respective units in order to realize various functions as the transaction processing apparatus 100 in accordance with an operating system and an information processing program such as an application program.

The main storage device 102 corresponds to the main storage part of the computer. The main storage device 102 includes a read-only memory area and a rewritable memory area. The main storage device 102 stores part of the information processing program in the read-only memory area. Further, the main storage device 102 stores, in the read-only memory area or rewritable memory area, data necessary for the processor 101 to execute processing for controlling the respective units, in some cases. The rewritable memory area of the main storage device 102 is used as a work area of the processor 101.

The auxiliary storage device 103 corresponds to an auxiliary storage part of the computer. As the auxiliary storage device 103, for example, an electric erasable programmable read-only memory (EEPROM), a hard disc drive (HDD), a solid state drive (SSD), or other various known storage devices can be used. The auxiliary storage device 103 stores data to be used for the processor 101 to perform various types of processing, and data generated by processing in the processor 101. The auxiliary storage device 103 stores the information processing program described above in some cases. In this embodiment, the auxiliary storage device 103 stores a transaction processing program PRA that is an information processing program. The transaction processing program PRA is an application program in which a procedure for information processing for registering a product that is a target of a transaction (hereinafter, referred to as a transaction product) and payment for registered transaction products (hereinafter, referred to as transaction processing) is described. Further, the transaction processing program PRA also describes a procedure for attendant support processing described below. Part of the storage area of the auxiliary storage device 103 is used as an area for storin a product master database DBA and transaction data DAA. The product master database DBA is a collection of various types of data for managing individual products that can be registered as transaction products. The transaction data DAA is data representing the content of one transaction.

The communication device 104 executes communication processing for performing data communication via the communication network 2. As the communication device 104, for example, an existing wired communication device for the Internet can be used. Note that as the communication device 104, a wireless communication device to be connected to the communication network 2 through wireless communication may be used instead or in addition to the wired communication device. The transmission path 105 includes an address bus, a data bus, a control signal line, and the like, and transmits data to be transmitted/received to/from the respective units connected to each other and a control signal.

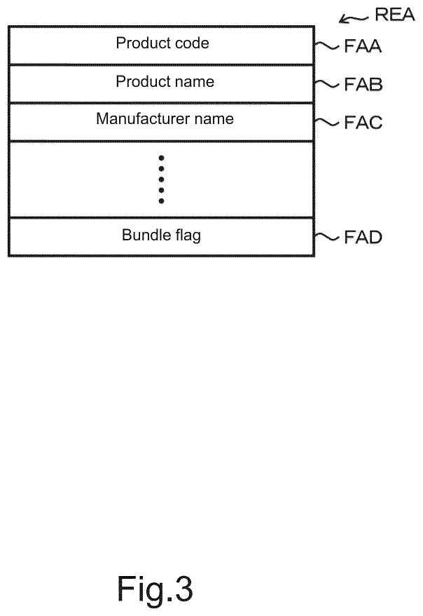

FIG. 3 is a diagram schematically showing a configuration of one data record REA included in the product master database DBA. The product master database DBA is a collection of a plurality of data records REA associated with each product that can be registered as a transaction product (i.e., a product that can be purchased by a customer in a store). As shown in FIG. 3, the data record REA has fields FAA, FAB, FAC, and FAD. In the field FAA, a product code as an identifier for the associated product is set. In the field FAB, a product name given to the associated product is set. In the field FAC, a manufacturer name of the associated product is set. The data record REA has a plurality of fields (not shown) subsequent to the field FAC. In the plurality of fields, for example, various types of data to be used when performing transaction processing relating to the associated product, such as a unit price and an applicable tax category, are set. In the field FAD, a flag representing whether or not checking of a packaged bundle including the associated product is necessary (hereinafter, referred to as a bundle flag) is set. The bundle flag selectively takes on two states representing “Checking necessary” or “Checking unnecessary”. The product associated with the data record REA in which the bundle flag set in the field FAD is in the state of representing “Checking necessary” is a product that needs to be checked.

The state of the bundle flag may be determined as appropriate by a sales manager of the associated product, or the like. Assumption is made that the bundle flag is made in the state of “Checking necessary” in the case where the associated product is a product sold individually and can be included in another packaged bundle, as an example. However, even in the case of the product satisfying this condition, whether the state of the product is made the state of “Checking necessary” or “Checking unnecessary” may be determined as appropriate for each product. For example, even in the case of the product satisfying the above condition, the bundle flag may be made in the state of “Checking unnecessary” in the case where the barcode displayed on the product is not exposed to the outside in the packaged bundle.

How many fields the data record REA has and what data is set in each field may be determined as appropriate by, for example, the designer, administrator, or the like of the transaction processing apparatus 100. The product master database DBA is updated by maintenance work in some cases in the case where a change such as an addition and deletion of a product that can be registered as a transaction product has occurred or a change such as a unit price change regarding a product that can be registered as a transaction product has occurred, but is not updated in accordance with various types of processing described below.

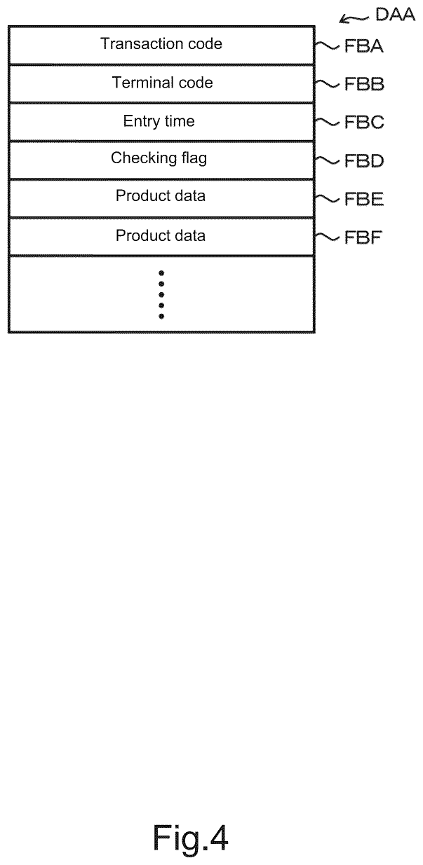

FIG. 4 is a diagram schematically showing a configuration of the transaction data DAA. The transaction data DAA is generated for each transaction being processed by the transaction processing apparatus 100 and stored in the auxiliary storage device 103. Thus, no transaction data DAA is stored in the auxiliary storage device 103 in some cases while a plurality of pieces of transaction data DAA is simultaneously stored in the auxiliary storage device 103.

The transaction data DAA has fields FBA, FBB, FBC, and FBD. The transaction data DAA may have an arbitrary number of fields subsequent to the field FBD. In the field FBA, a transaction code as an identifier for the corresponding transaction is set. In the field FBB, a terminal code as an identifier for the cart terminal 400 used by the customer who performs the corresponding transaction is set. In the field FBC, the entry time of the customer who uses the associated cart terminal 400 is set. In the field FBD, a flag for managing setting relating to checking by a sales clerk before payment relating to the corresponding transaction (hereinafter, referred to as a checking flag) is set. The checking flag selectively takes on three states representing “Not applicable”, “Checking necessary”, and “Checking unnecessary”. In the case where there is a product that has been registered as a transaction product, fields FBE, FBF, . . . , which are associated with the respective transaction products, are added to the transaction data DAA. In the fields FBE, FBF, . . . , pieces of product data relating to separate transaction products are set. The product data includes a product code as an identifier for the corresponding transaction product and the number of products. The product data may include other various types of information such as a product name, a unit price, and discount information. The transaction data DAA is appropriately generated by transaction processing described below and updated.

As hardware of the transaction processing apparatus 100, for example, a general-purpose server apparatus can be used. The transaction processing apparatus 100 is generally transferred while the transaction processing program PRA is stored in the auxiliary storage device 103 and the transaction data DAA and a tag table TAA are not stored. However, hardware with the auxiliary storage device 103 not storing the transaction processing program PRA or hardware with the auxiliary storage device 103 storing another version of the same type of application program, and the transaction processing program PRA may be individually transferred. The transaction processing apparatus 100 may be configured by writing the transaction processing program PRA to the auxiliary storage device 103 in accordance with an arbitrary worker's operation. The transaction processing program PRA can be transferred by being recorded on a removable recording medium such as a magnetic disc, a magneto-optical disc, an optical disc, and a semiconductor memory or through communication via a network.

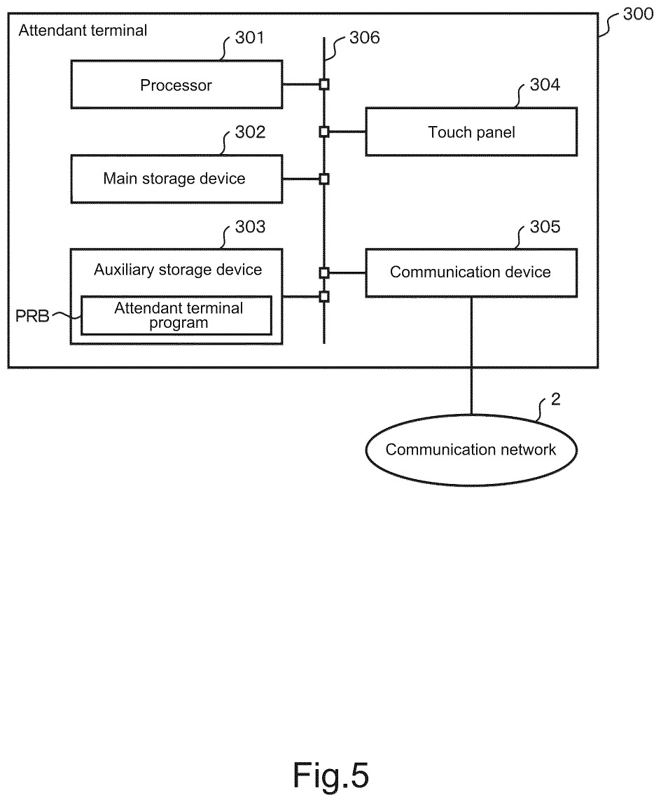

FIG. 5 is a block diagram showing a main circuit configuration of the attendant terminal 300. The attendant terminal 300 includes a processor 301, a main storage device 302, an auxiliary storage device 303, a touch panel 304, a communication device 305, a transmission path 306, and the like.

Since an overview of each of the functions of the processor 301, the main storage device 302, the auxiliary storage device 303, the communication device 305, and the transmission path 306 is similar to those of the processor 101, the main storage device 102, the auxiliary storage device 103, the communication device 104, and the transmission path 105, description thereof is omitted. However, the auxiliary storage device 303 stores an attendant terminal program PRB instead of the transaction processing program PRA. The attendant terminal program PRB is an application program in which a procedure for information processing by the processor 301 for causing an information processing apparatus to operate as the attendant terminal 300 is described.

The touch panel 304 displays a screen for presenting information to an operator of the attendant terminal 300. Further, the touch panel 304 inputs an instruction by a touch operation on the screen by the operator. As hardware of the attendant terminal 300, for example, a stationary computer apparatus is used. As hardware of the attendant terminal 300, a tablet information processing apparatus or a mobile information processing apparatus such as a smartphone may be used.

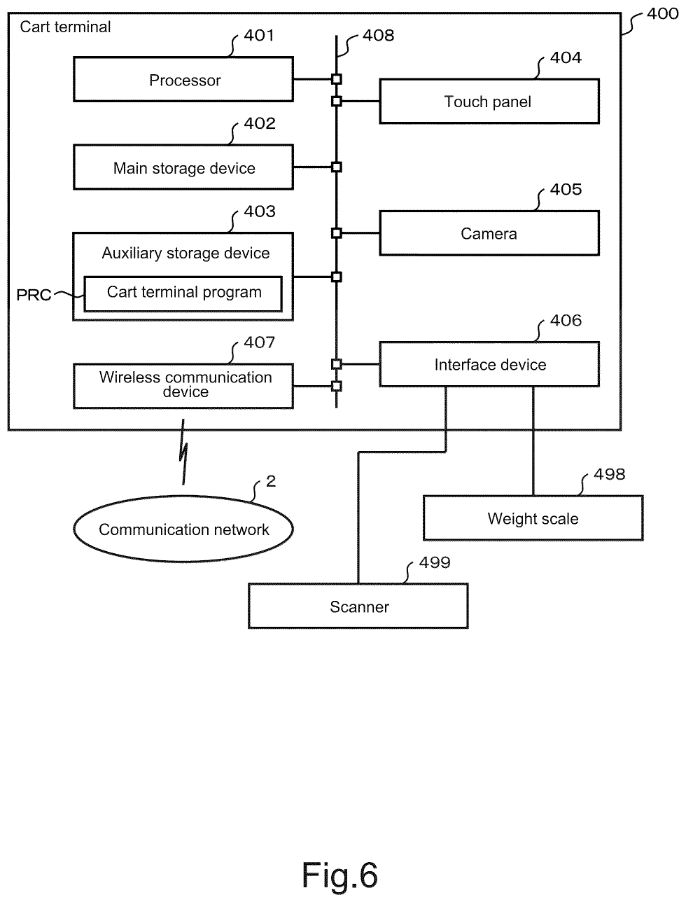

FIG. 6 is a block diagram showing a main circuit configuration of the cart terminal 400. The cart terminal 400 includes a processor 401, a main storage device 402, an auxiliary storage device 403, a touch panel 404, a camera 405, an interface device 406, a wireless communication device 407, a transmission path 408, and the like.

An overview of each of the functions of the processor 401, the main storage device 402, the auxiliary storage device 403, and the transmission path 408 is similar to those of the processor 101, the main storage device 102, the auxiliary storage device 103, and the transmission path 105. Further, an overview of the function of the touch panel 404 is similar to that of the touch panel 304. However, the auxiliary storage device 403 stores a cart terminal program PRC instead of the transaction processing program PRA. The cart terminal program PRC is an application program in which a procedure for information processing by the processor 401 for causing an information processing apparatus to operate as the cart terminal 400 is described.

The camera 405 takes an image in an imaging range including the entire internal space of a shopping basket placed on a cart to obtain an image. This image obtained by the camera 405 will be referred to as a camera image below. External devices such as a weight scale 498 and a scanner 499 are connected to the interface device 406. The interface device 406 is an interface that transmits/receives data to/from the external devices connected thereto. As the interface device 406, an existing universal serial bus(USB) controller or the like can be used. Note that the weight scale 498 measures the weight of the shopping basket placed on the cart together with the weight of products added to the shopping basket. Further, the scanner 499 is installed in the cart and optically scans a one-dimensional barcode, a two-dimensional barcode, or the like.

The wireless communication device 407 executes communication processing for wirelessly performing data communication via the communication network 2. As the wireless communication device 407, for example, an existing wireless communication device for wireless LAN can be used. Note that instead of or in addition to the wireless communication device 407, a communication device to be wired connected to the communication network 2 may be used. Assumption is made that as basic hardware of the cart terminal 400, for example, hardware of a tablet information processing apparatus is used.

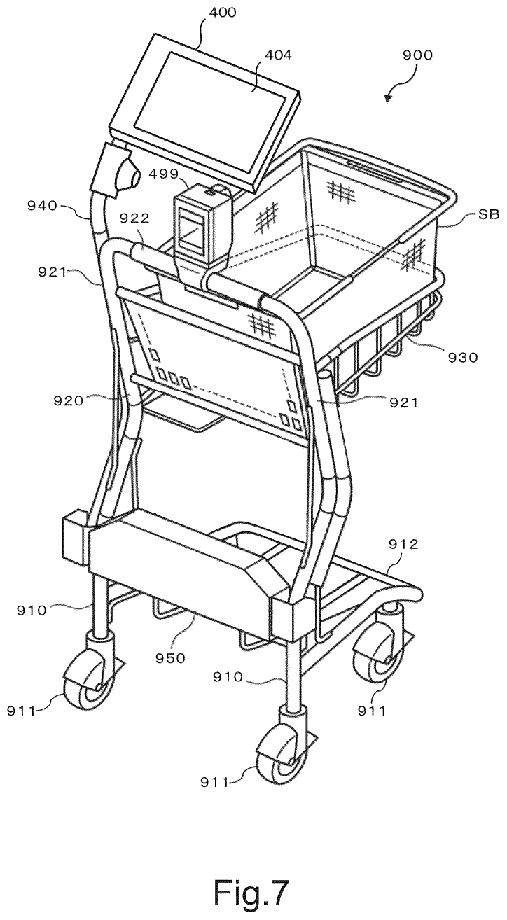

FIG. 7 is a perspective view showing an example of how the cart terminal 400 is installed in a cart. A cart 900 includes a caster portion 910, a handle frame portion 920, and a basket receiving portion 930. The caster portion 910 includes four wheels 911 for causing the cart 900 to smoothly move on the floor. The wheels 911 are attached to a frame 912 so as to be rotatable around an axis in the vertical direction.

The handle frame portion 920 includes a pair of vertical frames 921, 921, and a handle bar 922. The vertical frames 921, 921 are erected above the two wheels of the caster portion 910. The handle bar 922 connects the upper ends of the vertical frames 921, 921 to each other. The basket receiving portion 930 is provided horizontally from the midway portion of the handle frame portion 920. The basket receiving portion 930 holds a shopping basket SB for housing products. Note that the caster portion 910 is also capable of holding the shopping basket SB on the frame 912.

The scanner 499 is installed in the middle of the handle bar 922. Further, a pole 940 is attached to one vertical frame 921 such that the tip of the pole 940 is located above the handle bar 922. The above-mentioned cart terminal 400 is installed in the tip portion of this pole 940. The camera 405 of the cart terminal 400 is provided on the back side of the touch panel 404 of the cart terminal 400 and not shown in FIG. 7. This camera 405 is capable of imaging the inside of the shopping basket SB held by the basket receiving portion 930 from above with a bird's-eye view. A battery case 950 is attached to the lower end side of the handle frame portion 920 between the vertical frames 921, 921. The battery case 950 houses a battery to be used as an external power source of the cart terminal 400.

Next, an operation of the transaction processing system 1 configured as described above will be described. Note that the content of various types of processing described below is merely an example, and it is possible to change the order of some processes, omit some processes, or add another process as appropriate. For example, in the following description, description of some processes is omitted in order to describe characteristic operations of this embodiment in an easy-to-understand manner. For example, a process for excluding a product that has been registered as a transaction product from a transaction product or changing the number of products that have been registered as transaction products is performed, but description of this process is omitted. Further, for example, in the case where some error has occurred, a process for dealing with this error is performed in some cases. However, description of such a process is omitted.

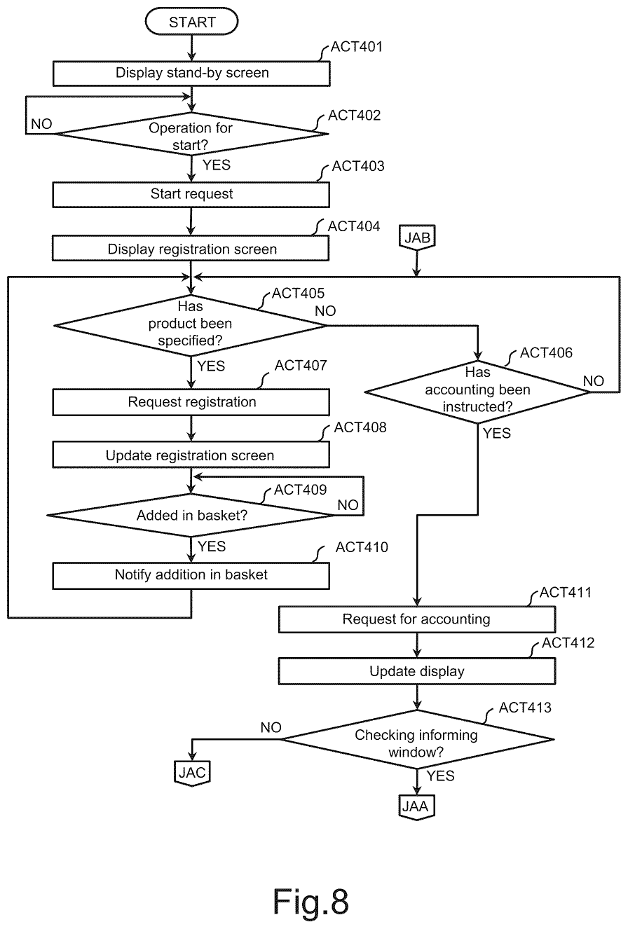

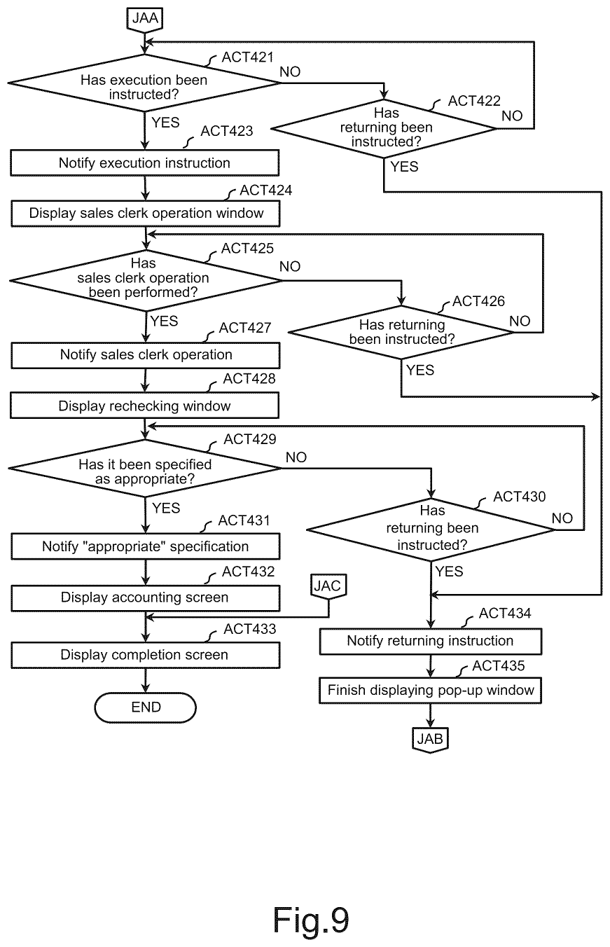

When the cart terminal 400 is in an operation state in which it is used by a customer, the processor 401 executes information processing for a user interface relating to registration of a transaction product (hereinafter, referred to as cart processing) on the basis of the cart terminal program PRC. FIG. 8 and FIG. 9 are each a flowchart of the cart processing.

In ACT401 in FIG. 8, the processor 401 of the cart terminal 400 displays a stand-by screen on the touch panel 404. The stand-by screen is a screen for informing a customer of that the cart terminal 400 is in a stand-by state and the customer can newly start using the cart terminal 400. The processing of the processor 401 proceeds to ACT402 while displaying the stand-by screen. In ACT402, the processor 401 stands by until a customer performs an operation for starting use.

The customer performs a predetermined operation for starting use on the cart terminal 400 in the stand-by state. The customer can also perform an operation for inputting a customer code to the cart terminal 400 as part of the operation for starting use. In the case where the processor 401 determines that such an operation for starting use has been performed (YES in ACT402), the processing of the processor 401 proceeds to ACT403.

In ACT403, the processor 401 requests the transaction processing apparatus 100 to start processing relating to one transaction. That is, the processor 401 transmits, for example, request data for check-in requests, which is addressed to the transaction processing apparatus 100, from the wireless communication device 407 to the communication network 2. The processor 401 causes the request data to include check-in data stored in the auxiliary storage device 403 and the terminal code of the cart terminal 400. Note that the terminal code is assigned to the cart terminal 400 in advance such that it can be distinguished from the other cart terminals 400, and stored in, for example, the auxiliary storage device 403. In the case where a customer code is input, the processor 401 causes request data to include this customer code. The check-in data includes at least information for identifying a store where the cart terminal 400 is used. This information is, for example, a store code determined as an identifier of a store. The information may be, for example, a company code for identifying a company as long as there is no need to distinguish between a plurality of stores operated by the same company. Further, the information may include, for example, a company code and a store code as long as the same store code can be used between different companies. However, in the case where the transaction processing apparatus 100 is operated as a local server, it is unnecessary to cause request data to include a store code.

When the check-in data has been transmitted to the transaction processing apparatus 100 via the communication network 2, the transaction processing apparatus 100 receives the check-in data by the communication device 104 and temporarily stores the received check-in data in the main storage device 102 or the auxiliary storage device 103. When the check-in data transmitted from the cart terminal 400 is received by the transaction processing apparatus 100 in this way, the processor 101 of the transaction processing apparatus 100 starts transaction processing relating to one transaction in accordance with the transaction processing program PRA.

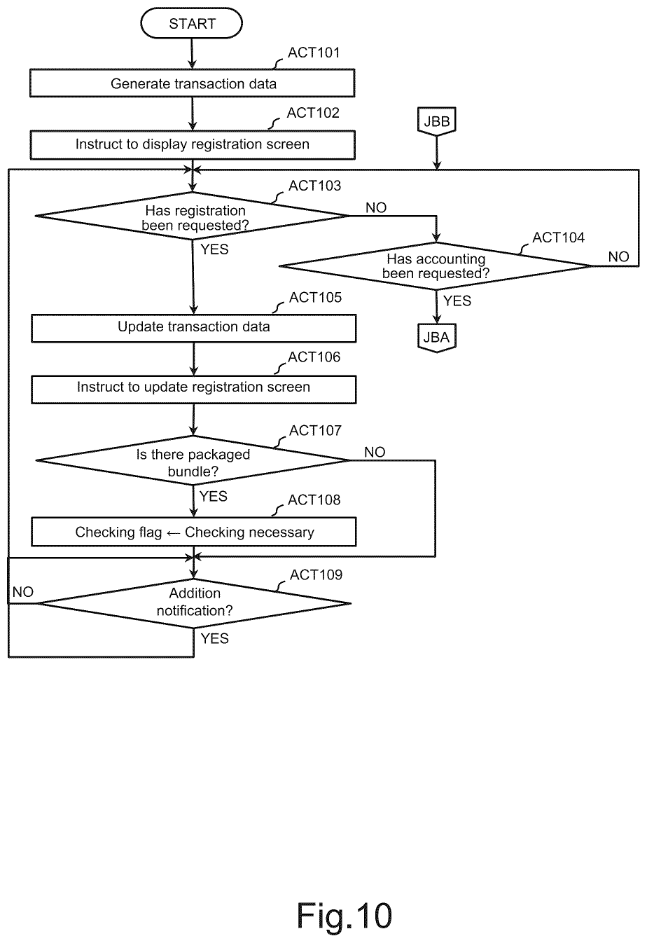

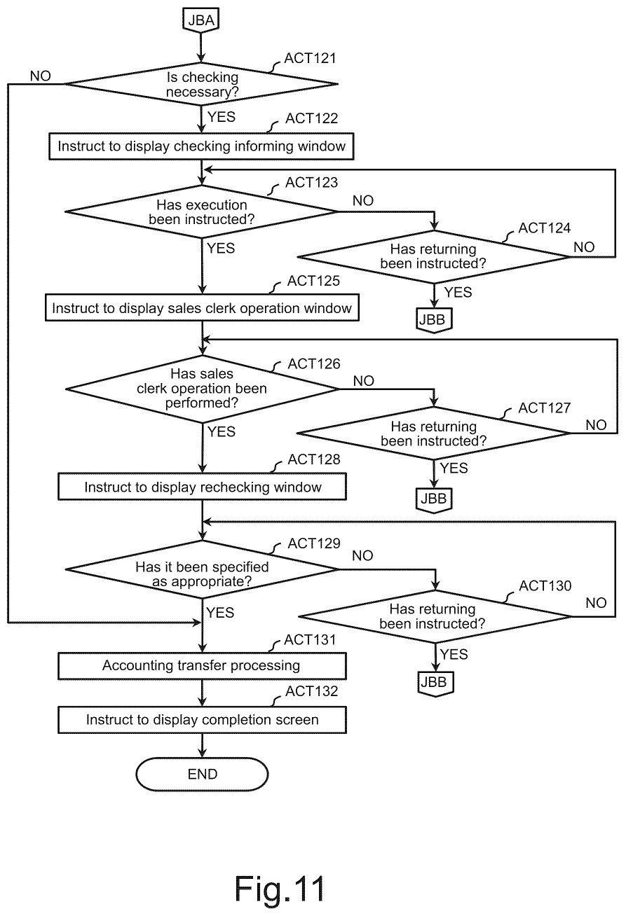

In the case where the processor 101 is executing transaction processing for another transaction relating to a different customer, the processor 101 starts new transaction processing as processing in a thread different from that of the transaction processing. That is, the processor 101 executes a plurality of pieces of transaction processing in parallel in some cases. However, in the following description, processing of a transaction relating to one customer will be focused on. The “cart terminal 400” in the following description refers to one cart terminal 400 used by a customer for the focused transaction processing. Further, the “transaction” in the following description refers to a transaction that is a target of the focused processing. FIG. 10 and FIG. 11 are each a flowchart of transaction processing.

In ACT101, the processor 101 of the transaction processing apparatus 100 generates new transaction data DAA (see FIG. 4) relating to a target transaction and stores the generated transaction data DAA in the auxiliary storage device 103. The processor 101 determines a new transaction code different from a transaction code for identifying another transaction in accordance with a predetermined rule, and sets, for example, the determined transaction code in the field FBA of the new transaction data DAA. The processor 101 sets, for example, a terminal code included in request data in the field FBB of the new transaction data DAA. The processor 101 sets, for example, the current date and time as the entry date and time in the field FBC of the new transaction data DAA. The entry date and time included in request data may be set in the field FBC. In this case, the processor 401 of the cart terminal 400 causes request data to include, for example, the date and time at which an operation for starting use was performed or the date and time at which request data was generated, as the entry date and time. The processor 101 sets, for example, the state of a checking flag set in the field FBD of the new transaction data DAA to the state representing “Not applicable”. Note that in the case where request data includes a customer code, the processor 101 sets the customer code in the new transaction data DAA. The processor 101 of the transaction processing apparatus 100 does not cause the newly generated transaction data DAA to include product data because it is before registering a transaction product.

In ACT102, the processor 101 instructs the cart terminal 400 to display a registration screen. The processor 101 transmits, for example, instruction data for instructing to display a registration screen, which is addressed to the cart terminal 400, from the communication device 104 to the communication network 2. The processor 101 generates, for example, screen data of a registration screen and causes instruction data to include the generated screen data. Alternatively, the processor 101 may cause, for example, instruction data to include data to be displayed on a registration screen, instead of screen data of a registration screen.

When the instruction data is transmitted via the communication network 2 and received by the wireless communication device 407 of the cart terminal 400, the processing of the processor 401 proceeds to ACT404 in FIG. 8. In ACT404, the processor 401 displays a registration screen corresponding to instruction data on the touch panel 404. In the case where instruction data includes screen data, for example, the processor 401 displays a screen represented by the screen data on the touch panel 404. In the case where instruction data includes data to be displayed on a registration screen, for example, the processor 401 generates a registration screen by expanding a display object corresponding to the data into a predetermined form of a registration screen, and displays the generated registration screen on the touch panel 404. Note that display of various other screens in the cart terminal 400 described below is performed by processing similar to that described above.

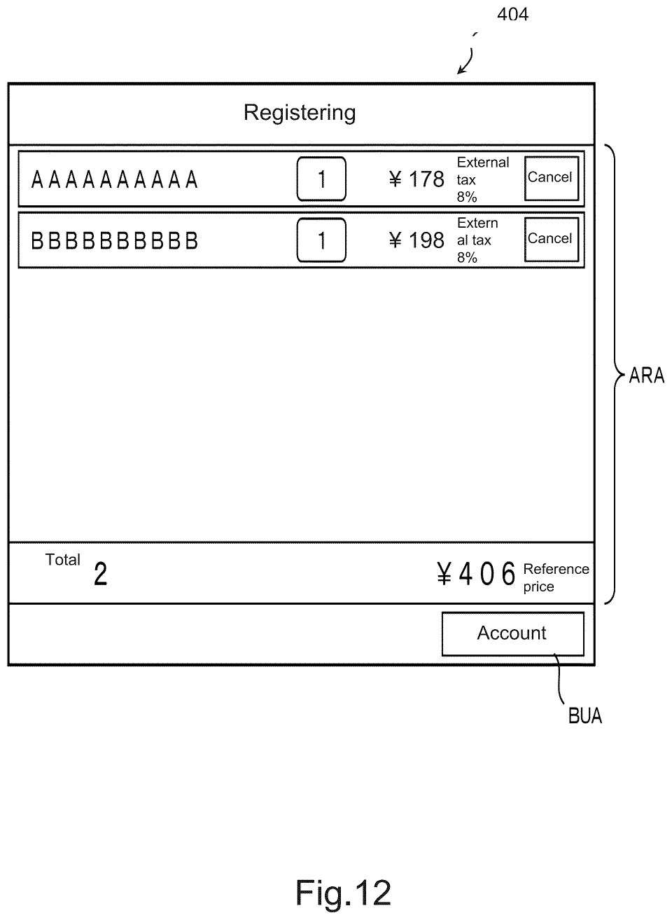

FIG. 12 is a diagram showing an example of a registration screen of the touch panel 404. Note that in the screen examples shown in FIG. 12 and the other figures, illustration of some display objects is omitted in some cases. An image representing a registration status is displayed in a display area ARA of a registration screen of the touch panel 404. The registration screen displays a button BUA. In the example of FIG. 12, the image displayed in the display area ARA shows the state where a total of two products whose product names are “AAAAAAAAAA” and “BBBBBBBBBB” and unit prices are 178 yen and 198 yen have been registered and the reference price is 406 yen. Note that the reference price is the amount of money obtained by subtracting a discount amount for various services such as coupon services from the sum of the unit prices of all transaction products. In the case where payment is made in the transaction with the transaction product and applicable service unchanged, this reference price is used as the payment amount. Note that the image displayed in the display area ARA sequentially changes depending on the registration status of the transaction product. Since no transaction product has been registered when the processor 101 of the transaction processing apparatus 100 executes the processing of ACT102 in FIG. 10 for the first time, information regarding each product is not displayed in the display area ARA of the registration screen of the touch panel 404 at this time and an image showing that the total number of products is 0 and the reference price is 0 yen is displayed. The button BUA is a soft key for an operator to instruct accounting.

A customer searches for a product that is a target of a transaction while moving in a store with the cart terminal 400. In the case where a product is newly registered as a transaction product, the customer performs a predetermined operation for specifying the product on the cart terminal 400. The operation is, for example, an operation for causing the scanner 499 to scan a barcode representing a product code such as a Japanese article number (JAN) code. The operation is, for example, an operation of tapping a preset button that is displayed on the display screen of the touch panel 404, products being associated with the preset button. The operation is, for example, an operation of directly inputting a product code with the touch panel 404.

In ACT405 in FIG. 8, the processor 401 of the cart terminal 400 determines whether or not a product to be registered has been specified. In the case where the processor 401 determines that a product to be registered has not been specified (NO in ACT405), the processing of the processor 401 proceeds to ACT406. In ACT406, the processor 401 determines whether or not accounting has been instructed. In the case where the processor 401 determines that accounting has not been instructed (NO in ACT406), the processing of the processor 401 returns to ACT405. In this way, in ACT405 and ACT406, the processor 401 stands by until product specification or an account instruction is received. In the case where the processor 401 determines that a product to be registered has been specified (YES in ACT405), the processing of the processor 401 proceeds to ACT407. In ACT407, the processor 401 requests the transaction processing apparatus 100 for product registration with notification of the product code of the specified product.

In the transaction processing apparatus 100, after the processor 101 instructs the cart terminal 400 to display a registration screen (ACT102 in FIG. 10), the processing of the processor 101 proceeds to ACT103. In ACT103, the processor 101 determines whether or not product registration has been requested. In the case where the processor 101 determines that product registration has not been requested (NO in ACT103), the processing of the processor 101 proceeds to ACT104. In ACT104, the processor 101 determines whether or not an accounting start has been requested. In the case where the processor 101 determines that an accounting start has not been requested (NO in ACT104), the processing of the processor 101 returns to ACT103. In this way, in ACT103 and ACT104, the processor 101 stands by until registration or accounting is requested. In the case where the processor 101 determines that product registration has been requested (YES in ACT103), the processing of the processor 101 proceeds to ACT105.

In ACT105, in accordance with the product registration request, the processor 101 updates the transaction data DAA (see FIG. 4) such that product data regarding a product that is a request target is included, and thus registers the product as a transaction product. In ACT106, the processor 101 instructs the cart terminal 400 to update the registration screen to display an image corresponding to the updated transaction data DAA in the display area ARA of the registration screen of the cart terminal 400.

In ACT107, the processor 101 checks whether or not there is a packaged bundle including the registered transaction product. The processor 101 checks, for example, a bundle flag set in the field FAD of the data record REA (see FIG. 3) associated with the registered transaction product in the product master database DBA. In the case where the bundle flag set in the field FAD is in the state representing “Checking necessary”, the processor 101 determines that there is a packaged bundle including the registered transaction product (YES in ACT107). The processing of the processor 101 proceeds to ACT108.

In ACT108, the processor 101 makes the state of the checking flag set in the field FBD of the transaction data DAA the state representing “Checking necessary”. The processing of the processor 101 then proceeds to ACT109. Meanwhile, in the case where the bundle flag set in the field FAD of the data record REA is in the state representing “Checking unnecessary”, the processor 101 determines that there is no packaged bundle including the registered transaction product (NO in ACT107). The processing of the processor 101 skips ACT108 and proceeds to ACT109. In ACT109, the processor 101 stands by for receiving addition notification described below.

The processing of the processor 401 of the cart terminal 400 proceeds to ACT408 after the request for registration in ACT407 in FIG. 8. In ACT408, the processor 401 updates the registration screen displayed on the touch panel 404 in accordance with the above-mentioned update instruction by the processor 101 (see ACT106). In ACT409, the processor 401 stands by until a product is added to the shopping basket SB held in the basket receiving portion 930 of the cart 900 in which the cart terminal 400 is installed.

When the customer has finished the above-mentioned operation for specifying a product to be registered as a transaction product, he/she adds the product to the shopping basket SB. Note that placing the specified product in the shopping basket SB before performing an operation of specifying another product next is a rule when using the cart terminal 400 by the customer.

When a product is added to the shopping basket SB, the measured value by the weight scale 498 changes. The processor 401 monitors such a change in the measured value to detect addition of a product to the shopping basket SB. When the processor 401 detects addition of a product (YES in ACT409), the processing of the processor 401 proceeds to ACT410. The processor 401 executes information processing based on the cart terminal program PRC in this way, and thus, a computer including the processor 401 as a central part realizes a function as a detection means in cooperation with the weight scale 498.

In ACT410, the processor 401 notifies the transaction processing apparatus 100 of addition of a product to the basket. The processor 401 transmits, for example, predetermined notification data for notifying addition of a product to the basket, which is addressed to the transaction processing apparatus 100, from the wireless communication device 407 to the communication network 2. The processor 401 acquires a camera image obtained by the camera 405 after detecting the product addition and causes the above notification data to include the acquired camera image. The processing of the processor 401 then returns to a stand-by state in ACT405 and ACT406.

In the transaction processing apparatus 100, in the case where the processor 101 determines that the communication device 104 has received the above notification data for addition notification (YES in ACT109), the processing of the processor 101 returns to a stand-by state in ACT103 and ACT104.

The transaction processing apparatus 100 executes, on the basis of the transaction processing program PRA, attendant support processing that is information processing for supporting a sales clerk (attendant) who uses the attendant terminal 300, as processing a thread different from that of the transaction processing. Note that the transaction processing and the attendant support processing may be executed on the basis of individual information processing programs.

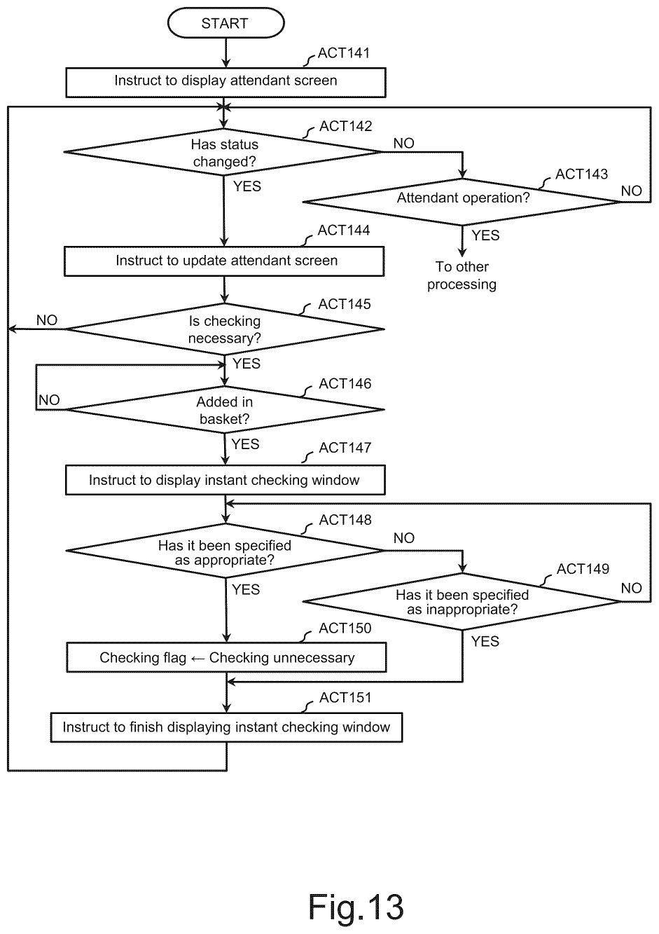

FIG. 13 is a flowchart showing attendant support processing. In ACT141, the processor 101 instructs the attendant terminal 300 to display an attendant screen. The attendant screen is a screen for causing a sales clerk (attendant) to check the transaction progress status for each cart terminal 400. The processor 101 transmits, for example, instruction data for instructing to display an attendant screen, which is addressed to the attendant terminal 300, from the communication device 104 to the communication network 2. The processor 101 generates, for example, screen data of an attendant screen, and causes instruction data to include the generated screen data. Alternatively, the processor 101 may cause instruction data to include, for example, data to be displayed on an attendant screen instead of screen data of an attendant screen.

When instruction data of an attendant screen is received by the communication device 305, the processor 301 of the attendant terminal 300 displays an attendant screen corresponding to this instruction data on the touch panel 304. In the case where instruction data includes screen data, for example, the processor 301 displays a screen represented by the screen data on the touch panel 304. In the case where instruction data includes data to be displayed on an attendant screen, for example, the processor 301 generates an attendant screen by expanding a display object corresponding to the data into a predetermined form of an attendant screen, and displays the generated attendant screen on the touch panel 304. Note that display of various other screens in the attendant terminal 300 described below is performed by processing similar to that described above.

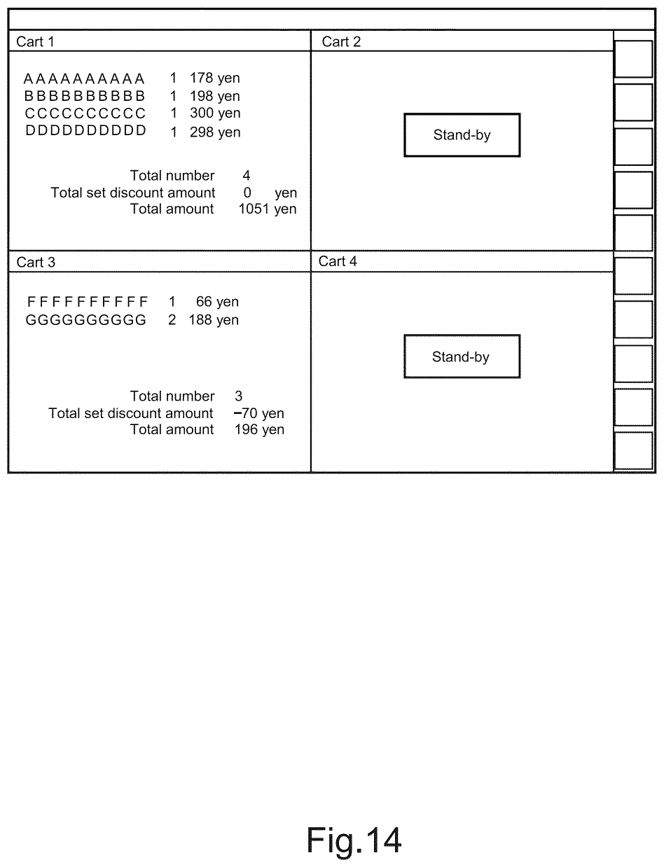

FIG. 14 is a diagram showing an example of an attendant screen. The attendant screen shown in FIG. 14 displays, in four display areas, the transaction progress statuses of four cart terminals 400. In the example shown in FIG. 14, the attendant screen displays a situation where a transaction product has been successfully registered in two cart terminals 400 and the other two cart terminals 400 are not used by customers. For example, in the case where the transaction products registered by the corresponding cart terminal 400 include a product that needs verification of the age of the purchaser, display for notifying a sales clerk of such a situation may be included in each display area.

The processing of the processor 101 of the transaction processing apparatus 100 proceeds to ACT142 after instructing to display an attendant screen in ACT141 in FIG. 13. In ACT142, the processor 101 determines whether or not the transaction progress status in each of the cart terminals 400 has changed. In the case where the processor 101 determines that the transaction progress status in the cart terminal 400 has not changed (NO in ACT142), the processing of the processor 101 proceeds to ACT143. In ACT143, the processor 101 determines whether or not an operation by a sales clerk (attendant) has been performed on the attendant terminal 300. In the case where the processor 101 determines that an operation by a sales clerk (attendant) has not been performed on the attendant terminal 300 (NO in ACT143), the processing of the processor 101 returns to ACT142. In this way, the processor 101 stands by for a status change in the cart terminal 400 or an operation by a sales clerk (attendant) in ACT142 and ACT143. In the case where some operation by a sales clerk (attendant) has been performed on the attendant terminal 300 and the processor 101 is notified of it, the processor 101 determines that an operation by a sales clerk (attendant) has been performed on the attendant terminal 300 (YES in ACT143). The processing of the processor 101 proceeds to processing for supporting the operation by a sales clerk (attendant). Description of the processing of the processor 101 in this case is omitted here.

Further, when a change in the transaction progress status such as the update of the transaction data DAA as described above occurs, the processor 101 determines that the transaction progress status in the cart terminal 400 has changed (YES in ACT142). The processing of the processor 101 then proceeds to ACT144. In ACT144, the processor 101 instructs the attendant terminal 300 to update the attendant screen to reflect the change in the transaction progress status in the cart terminal 400.

In ACT145, the processor 101 determines whether or not checking relating to a packaged bundle is necessary. In the case where the above change in the transaction progress status is new registration of a transaction product and the bundle flag set in the field FAD of the data record REA associated with the transaction product in the product master database DBA is “Checking necessary”, for example, the processor 101 determines that checking relating to a packaged bundle is necessary (YES in ACT145). The processing of the processor 101 then proceeds to ACT146.

In ACT146, the processor 101 stands by until the newly registered transaction product is added to the basket. The processor 101 determines that, for example, the communication device 104 has received the notification data transmitted for the notification of addition of a product to the basket from the cart terminal 400 where the above new registration was performed (YES in ACT146). The processing of the processor 101 proceeds to ACT147. In ACT147, the processor 101 instructs the attendant terminal 300 to display an instant checking window. The instant checking window is a pop-up window for causing a sales clerk to instantly check the addition status of a product to the shopping basket SB.

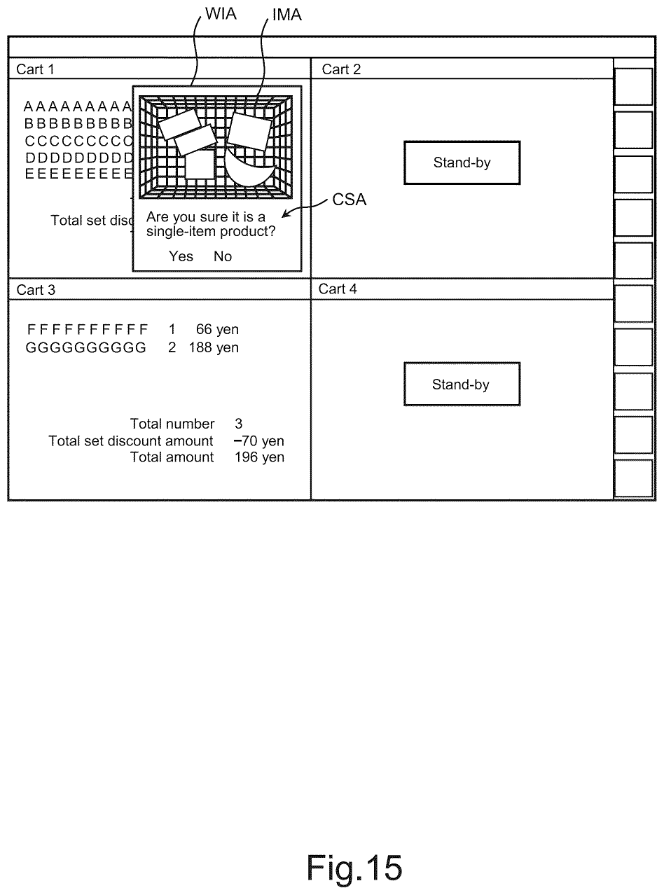

FIG. 15 is a diagram showing a display example of an instant checking window. An instant checking window WIA shown in FIG. 15 is displayed in the case where a product whose product name is “EEEEEEEEEE” in the cart terminal 400 referred to as a “cart 1” has been newly registered as a transaction product while the attendant screen is in the state shown in FIG. 14. That is, the instant checking window WIA is superimposed and displayed on the updated attendant screen in accordance with the new registration of the product whose product name is “EEEEEEEEEE” as a transaction product. The instant checking window WIA is display in the display area corresponding to the cart terminal 400 referred to as the “cart 1” in accordance with the fact that the product name whose product name is “EEEEEEEEEE” is a single-item product that can be included in a packaged bundle.

The instant checking window WIA displays a camera image IMA and a character string CSA. The camera image IMA is a camera image included in the notification data for notifying addition of a product to the basket. The character string CSA represents a text message prompting a sales clerk (attendant) to check whether or not the added product is a single-item product.

That is, the processor 101 of the transaction processing apparatus 100 acquires a camera image from the cart terminal 400 when the product whose product name is “EEEEEEEEEE”, which is a single-item product that can be contained in a packaged bundle, was added to the cart. The processor 101 displays the camera image on the attendant terminal 300. That is, the processor 101 executes information processing based on the transaction processing program PRA, and thus, a computer including the processor 101 as a central part functions as an acquisition means and a display means.

In this way, the sales clerk (attendant) can check whether or not the product added to the shopping basket SB is a single-item product by visually checking the camera image IMA represented in the instant checking window WIA. The sales clerk (attendant) checks that the product is a single-item product and then specifies that it is appropriate by a predetermined operation such as tapping a character string “Yes” in a text message MEA. Further, after checking that a single-item product is not added because a packaged bundle has been added, for example, the sales clerk specifies that it is inappropriate by a predetermined operation such as tapping a character string “No” in the text message MEA. The processor 301 of the attendant terminal 300 notifies, upon accepting such specification, the transaction processing apparatus 100 of which designation has been made.

The processing of the processor 101 of the transaction processing apparatus 100 proceeds to ACT148 after instructing to display the checking window in ACT147 in FIG. 13. In ACT148, the processor 101 determines whether or not it has been specified as appropriate in the instant checking window WIA of the attendant terminal 300. In the case where the processor 101 determines that it has not been specified as appropriate (NO in ACT148), the processing of the processor 101 proceeds to ACT149. In ACT149, the processor 101 determines whether or not it has been specified as inappropriate in the instant checking window WIA of the attendant terminal 300. In the case where the processor 101 determines that it has not been specified as inappropriate (NO in ACT149), the processing of the processor 101 returns to ACT148. In this way, the processor 101 stands by until it is specified as appropriate or inappropriate in ACT148 and ACT149. In the case where the processor 101 determines that it has been specified as appropriate in the instant checking window WIA of the attendant terminal 300 (YES in ACT148), the processing of the processor 101 proceeds to ACT150.

In ACT150, the processor 101 makes the state of the checking flag set in the field FBD of the transaction data DAA relating to the transaction the state representing “Checking unnecessary”. The processing of the processor 101 then proceeds to ACT151. Note that in the case where the processor 101 determines that it has been specified as inappropriate in the instant checking window WIA of the attendant terminal 300 (YES in ACT149), the processing of the processor 101 skips ACT150 and proceeds to ACT151.

In ACT151, the processor 101 instructs the attendant terminal 300 to finish displaying the instant checking window WIA. The processor 301 of the attendant terminal 300 finishes displaying the instant checking window WIA in accordance with this instruction. Note that the processing of the processor 101 then returns to the stand-by state in ACT142 and ACT143. Note that in the case where it is determined that checking regarding a packaged bundle is unnecessary (NO in ACT145), the processing of the processor 101 returns to the stand-by state in ACT142 and ACT143 without executing the processing of ACT146 to ACT151.

After finishing the registration of a transaction product, the customer performs a predetermined operation for instructing accounting on the cart terminal 400. In the case where the processor 401 of the cart terminal 400 determines, in accordance with such an operation, that accounting has been instructed (YES in ACT406 in FIG. 8), the processing of the processor 401 proceeds to ACT411. In ACT411, the processor 401 requests the transaction processing apparatus 100 for accounting.

In the case where the processor 101 of the transaction processing apparatus 100 determines, in accordance with this request, that an accounting start has been requested (YES in ACT104 in FIG. 10), the processing of the processor 101 proceeds to ACT121 in FIG. 11. In ACT121, the processor 101 determines whether or not checking of a packaged bundle is necessary. In the case where, for example, the checking flag set in the field FBD of the transaction data DAA is in the state representing “Checking necessary”, the processor 101 determines that checking of a packaged bundle is necessary (YES in ACT121). The processing of the processor 101 proceeds to ACT122. In ACT122, the processor 101 instructs the cart terminal 400 to display a checking informing window. The checking informing window is a window for informing a customer of that checking by a sales clerk is necessary.

The processing of the processor 401 of the cart terminal 400 proceeds to ACT412 after the request for accounting in ACT411 in FIG. 8. In ACT412, the processor 401 updates the display of the touch panel 404 in accordance with an instruction from the transaction processing apparatus 100. That is, in the case where display of a checking informing window has been instructed as described above, the processor 401 displays a checking informing window on the touch panel 404. Note that the processor 401 superimposes and displays a checking informing window and various other windows described below on the registration screen displayed on the touch panel 404 before displaying the windows. However, each window may be displayed instead of the registration screen.

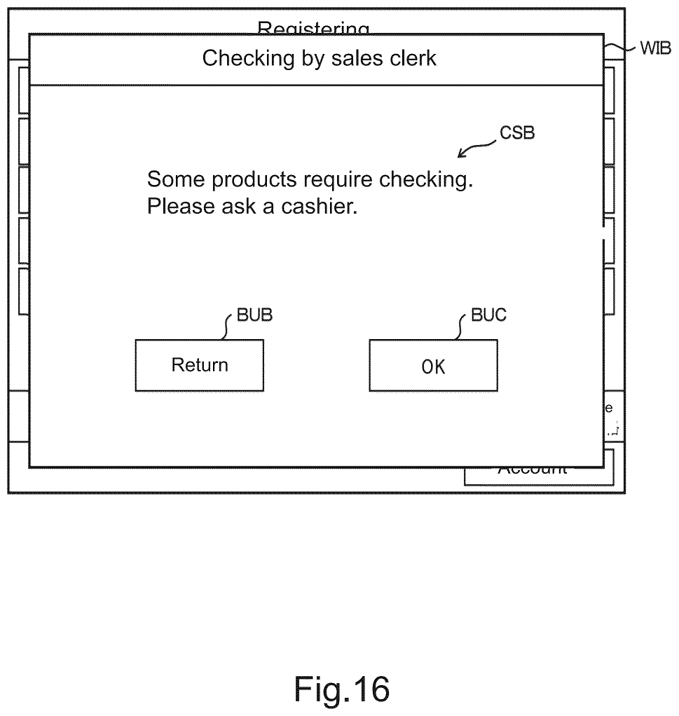

FIG. 16 is a diagram showing an example of a checking informing window. A checking informing window WIB shown in FIG. 16 displays a character string CSB and buttons BUB and BUC. The character string CSB is a text message for informing a customer of that checking by a sales clerk is necessary. The button BUB is a soft key for an operator (customer) to instruct to return to the state for performing product registration. The button BUC is a soft key for an operator to instruct to execute a checking procedure by a sales clerk.

In the case where the customer desires to perform accounting as he/she is, he/she instructs to execute a checking procedure by a sales clerk by a predetermined operation such as tapping the button BUC. Before or after the operation, the customer requests a sales clerk for checking. Alternatively, a sales clerk requested from the customer instructs to execute a checking procedure by the sales clerk by a predetermined operation such as tapping the button BUC.

The processing of the processor 401 proceeds to ACT413 after displaying a pop-up window in ACT412 in FIG. 8. In ACT413, the processor 401 determines whether or not the pop-up window displayed on the touch panel 404 (see ACT412) is the checking informing window WIB. In the case where the processor 401 determines that the pop-up window (see ACT412) is the checking informing window WIB (YES in ACT413), the processing of the processor 401 proceeds to ACT421 in FIG. 9. In ACT421, the processor 401 determines whether or not execution of a checking procedure by a sales clerk has been instructed. In the case where the processor 401 determines that execution of a checking procedure by a sales clerk has not been instructed (NO in ACT421), the processing of the processor 401 proceeds to ACT422. In ACT422, the processor 401 determines whether or not returning to product registration has been instructed. In the case where the processor 401 determines that returning to product registration has not been instructed (NO in ACT422), the processing of the processor 401 returns to ACT421. In this way, the processor 401 stands by for receiving an execution instruction or a returning instruction in ACT421 and ACT422. In the case where the processor 401 determines that execution of a checking procedure by a sales clerk has been instructed (YES in ACT421), the processing of the processor 401 proceeds to ACT423. In ACT423, the processor 401 notifies the transaction processing apparatus 100 of that execution of a checking procedure by a sales clerk has been instructed.

The processing of the processor 101 of the transaction processing apparatus 100 proceeds to ACT123 after finishing the display instruction in ACT122 in FIG. 11. In ACT123, the processor 101 determines whether or not execution of a checking procedure by a sales clerk has been instructed. In the case where the processor 101 determines that execution of a checking procedure by a sales clerk has not been instructed (NO in ACT123), the processing of the processor 101 proceeds to ACT124. In ACT124, the processor 101 determines whether or not returning to product registration has been instructed. In the case where the processor 101 determines that returning to product registration has not been instructed (NO in ACT124), the processing of the processor 101 returns to ACT123. In this way, the processor 101 stands by for receiving an execution instruction or a returning instruction in ACT123 and ACT124. In the case where the processor 101 determines that execution of a checking procedure by a sales clerk has been instructed (YES in ACT123), the processing of the processor 101 proceeds to ACT125. In ACT125, the processor 101 instructs the cart terminal 400 to display a sales clerk operation window. The sales clerk operation window is a window for informing reception of an operation by a sales clerk for starting checking by the sales clerk.

The processing of the processor 401 of the cart terminal 400 proceeds to ACT424 after notifying an execution instruction in ACT423 in FIG. 9. In ACT424, the processor 401 displays a sales clerk operation window on the touch panel 404 in accordance with the above display instruction from the transaction processing apparatus 100.

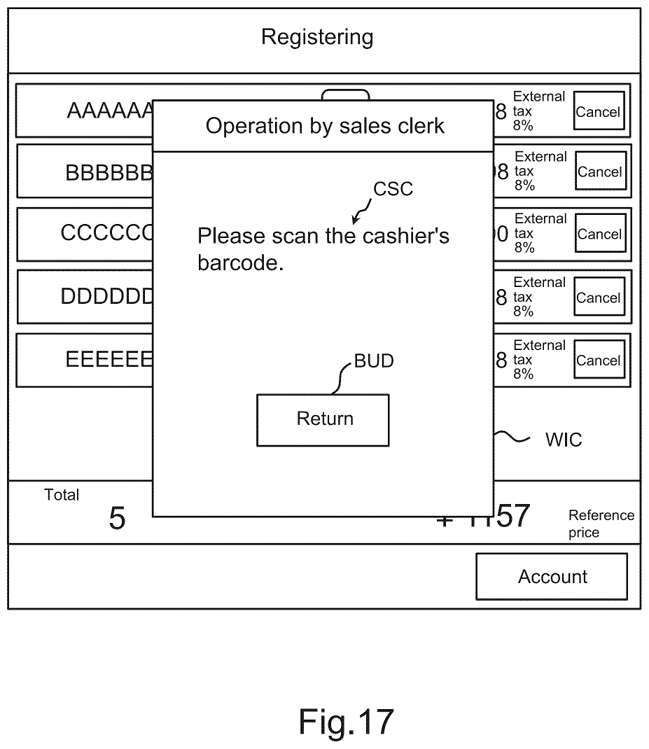

FIG. 17 is a diagram showing an example of a sales clerk operation window. A sales clerk operation window WIC displays a character string CSC and a button BUD. The character string CSC is a text message for informing a sales clerk of an operation to be performed by the sales clerk. In this embodiment, as an operation by a sales clerk for starting checking by the sales clerk, an operation of causing the camera 405 to scan the barcode that is displayed on the sales clerk′ ID and represents the sales clerk code as an identifier of the sales clerk is received. The character string CSC shown in FIG. 17 is a text message for informing the operation. The button BUD is a soft key for an operator to instruct to return to the state for performing product registration.

The sales clerk who has been requested for checking from a customer holds the barcode displayed on the sales clerk ID owned by the sales clerk up over the camera 405 to cause the camera 405 to scan it. Note that the operation to be performed by the sales clerk in this case may be changed to an arbitrary predetermined operation that customers do not normally perform, such as an operation of inputting a passcode for a sales clerk, or a plurality of types of operations may be received. Note that the sales clerk who performs the operation corresponds to an attendant who performs checking. Further, the reading of the sales clerk code from sales clerk ID may be performed by, for example, a card reader (not shown) externally attached to the cart terminal 400.

In ACT425 in FIG. 9, the processor 401 determines whether or not a sales clerk operation has been performed. In the case where the processor 401 determines that a sales clerk operation has not been performed (NO in ACT425), the processing of the processor 401 proceeds to ACT426. In ACT426, the processor 401 determines whether or not returning to product registration has been instructed. In the case where the processor 401 determines that returning to product registration has not been instructed (NO in ACT426), the processing of the processor 401 returns to ACT425. In this way, the processor 401 stands by for receiving a sales clerk operation or a returning instruction in ACT425 and ACT426. In the case where the processor 401 determines that a sales clerk operation has been performed (YES in ACT425), the processing of the processor 401 proceeds to ACT427. In ACT427, the processor 401 notifies the transaction processing apparatus 100 of that a sales clerk operation has been performed.

The processing of the processor 101 of the transaction processing apparatus 100 proceeds to ACT126 after finishing the display instruction in ACT125 in FIG. 11. In ACT126, the processor 101 determines whether or not a sales clerk operation has been performed. In the case where the processor 101 determines that a sales clerk operation has not been performed (NO in ACT126), the processing of the processor 101 proceeds to ACT127. In ACT127, the processor 101 determines whether or not returning to product registration has been instructed. In the case where the processor 101 determines that returning to product registration has not been instructed (NO in ACT127), the processing of the processor 101 returns to ACT126. In this way, the processor 101 stands by for receiving a sales clerk operation or a returning instruction in ACT126 and ACT127. In the case where the processor 101 determines that a sales clerk operation has been performed (YES in ACT126), the processing of the processor 101 proceeds to ACT128. In ACT128, the processor 101 instructs the cart terminal 400 to display a rechecking window. The rechecking window is a window for informing a sales clerk of visual rechecking by the sales clerk.

The processing of the processor 401 of the cart terminal 400 proceeds to ACT428 after notifying a sales clerk operation in ACT427 in FIG. 9. In ACT428, the processor 401 displays a rechecking window on the touch panel 404 in accordance with the above display instruction from the transaction processing apparatus 100.

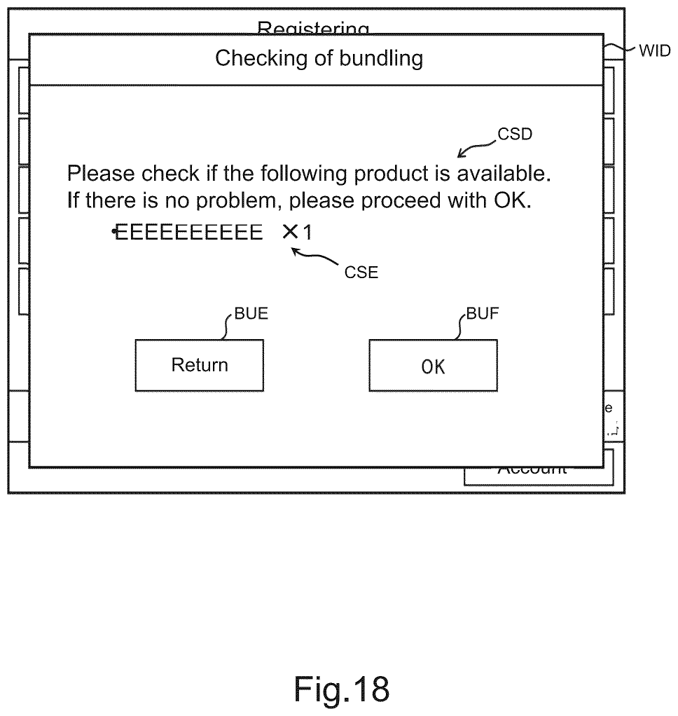

FIG. 18 is a diagram showing an example of a rechecking window. A rechecking window WID displays character strings CSD and CSE and buttons BUE and BUF. The character string CSD is a fixed text message for informing a sales clerk of work to be performed by the sales clerk. The character string CSE represents the product name and number of products to be checked regarding whether or not the corresponding product is added to the shopping basket SB. The processor 101 of the transaction processing apparatus 100 searches the product master database DBA for all the data records REA in which the product is set in the field FAA, for each product code included in each piece of product data included in the transaction data, for example. The processor 101 selects, from the corresponding data records REA, all data records REA in which the bundle flag set in the field FAD is in the state representing “Checking necessary”. The processor 101 generates the character string CSE such that the product name set in the field FAB of the selected data record REA and the number of products shown in the product data included in the transaction data including the product code set in the field FAA of the selected data record REA are represented. Note that FIG. 18 shows an example in which the number of products to be checked is one. In the case where there is a plurality of products to be checked, the character string CSE represents the product names and numbers of plurality of products. The button BUE is a soft key for an operator to instruct to return to the state for performing product registration. The button BUF is a soft key for an operator to instruct that the addition status of the product to be checked is appropriate.

In this way, the processor 101 performs, by displaying the rechecking window WID shown in FIG. 18 on the cart terminal 400, an informing operation for causing a sales clerk (attendant) to perform checking during payment of a product that needs to be checked. That is, the processor 101 executes information processing based on the transaction processing program PRA, and thus, a computer including the processor 101 as a central part functions as an informing means.

The sales clerk directly visually checks the product added to the shopping basket SB regarding whether or not the single-item product represented by the character string CSE of the rechecking window WID is correctly added to the shopping basket SB. In the case where the sales clerk determines that it is appropriate, he/she specifies that it is appropriate by a predetermined operation such as tapping the button BUF.

The processing of the processor 401 of the cart terminal 400 proceeds to ACT429 after displaying the rechecking window WID in ACT428 in FIG. 9. In ACT429, the processor 401 determines whether or not it has been specified as appropriate. In the case where the processor 401 determines that it has not been specified as appropriate (NO in ACT429), the processing of the processor 401 proceeds to ACT430. In ACT430, the processor 401 determines whether or not returning to product registration has been instructed. In the case where the processor 401 determines that returning to product registration has not been instructed (NO in ACT430), the processing of the processor 401 returns to ACT429. In this way, the processor 401 stands by for receiving “appropriate” specification or a returning instruction in ACT429 and ACT430. In the case where the processor 401 determines that it has been specified as appropriate (YES in ACT429), the processing of the processor 401 proceeds to ACT431. In ACT431, the processor 401 notifies the transaction processing apparatus 100 of “appropriate” specification.

The processing of the processor 101 of the transaction processing apparatus 100 proceeds to ACT129 after the display instruction in ACT128 in FIG. 11. In ACT129, the processor 101 determines whether or not it has been specified as appropriate. In the case where the processor 101 determines that it has not been specified as appropriate (NO in ACT129), the processing of the processor 101 proceeds to ACT130. In ACT130, the processor 101 determines whether or not returning to product registration has been instructed. In the case where the processor 101 determines that returning to product registration has not been instructed (NO in ACT130), the processing of the processor 101 returns to ACT129. In this way, the processor 101 stands by for receiving “appropriate” specification or a returning instruction in ACT129 and ACT130. In the case where the processor 101 is notified of “appropriate” specification from the cart terminal 400 as described above, the processor 101 determines that it has been specified as appropriate (YES in ACT129). The processing of the processor 101 proceeds to ACT131.

In ACT131, the processor 101 executes accounting transfer processing for transferring processing for accounting to the accounting machine 200. For example, the processor 101 instructs the cart terminal 400 to display an accounting screen first. The accounting screen is a screen for transferring account processing relating to a transaction to the accounting machine 200. A barcode representing information for the accounting machine 200 to make an inquiry about the corresponding transaction to the transaction processing apparatus 100 is displayed on the accounting screen.

The processing of the processor 401 of the cart terminal 400 proceeds to ACT432 after notifying “appropriate” specification in ACT431 in FIG. 9. In ACT432, the processor 401 displays an accounting screen on the touch panel 404 in accordance with the above display instruction from the transaction processing apparatus 100.

In the case where a plurality of accounting machines 200 is installed in the store, the customer arbitrarily selects the accounting machine 200 that is not in use therefrom, and causes a barcode scanner included in the accounting machine 200 to read the barcode represented on the accounting screen. In accordance with this, the accounting machine 200 requests the transaction processing apparatus 100 for accounting data on the basis of the information represented by the barcode read by the barcode scanner.

As part of the accounting transfer processing in ACT131 in FIG. 11, the processor 101 of the transaction processing apparatus 100 stands by until accounting data is requested, and transmits, upon receiving the request for accounting data as described above, accounting data for causing the accounting machine 200 to perform payment of the requested transaction to the accounting machine 200 that is the request source.

In this way, in accordance with the accounting data transmitted from the transaction processing apparatus 100, the accounting machine 200 executes processing for performing accounting of the transaction on the basis of the accounting data while appropriately displaying a screen and receiving a customer's operation relating to the accounting. This processing of the accounting machine 200 may be, for example, processing similar to the processing performed in an accounting machine in an existing POS system.

Note that the transfer of account processing relating to a transaction from the cart terminal 400 to the accounting machine 200 may be realized by, for example, transferring accounting data through wireless communication when the cart terminal 400 approaches a specific accounting machine 200, instead of the above. Further, in the case where the accounting machine 200 is in the form of a gate, accounting data relating to a transaction may be transferred to the accounting machine 200 when the cart terminal 400 approaches the gate.

As described above, the processor 101 of the transaction processing apparatus 100 displays the rechecking window WID (see FIG. 18) on the touch panel 404 of the cart terminal 400. Once a sales clerk checks that it is appropriate in accordance with this rechecking window WID, the processor 101 allows payment. That is, the processor 101 refrains payment until checking is completed. When the processor 101 executes information processing based on the transaction processing program PRA, a computer including the processor 101 as a central part functions as a refrain means.

In ACT132, the processor 101 instructs the cart terminal 400 to display a completion screen. The completion screen is a screen for notifying a customer of that the processing relating to the current transaction in the cart terminal 400 has been completed. In accordance with this, the processor 101 ends the transaction processing relating to this transaction.

The processing of the processor 401 of the cart terminal 400 proceeds to ACT433 after displaying the accounting screen in ACT432 in FIG. 9. In ACT433, the processor 401 displays a completion screen on the touch panel 404 in accordance with the above display instruction from the transaction processing apparatus 100. The processor 401 finishes displaying the completion screen with a predetermined condition such as that fact that the duration of the display of a completion screen exceeds a predetermined time is met, and then ends this cart processing. Note that immediately after that or in accordance with that fact that a predetermined restart condition is met, the processor 401 newly starts cart processing and stands by for use by a next customer.

Note that in the case where the customer desires to cancel proceeding to accounting and return to the state for performing product registration when the checking informing window WIB shown in FIG. 16 is displayed on the touch panel 404, he/she instructs to return by a predetermined operation such as tapping the button BUB. Further, in the case where the customer desires to cancel checking by a sales clerk and return to the state for performing product registration when the sales clerk operation window WIC shown in FIG. 17 is displayed on the touch panel 404, he/she instructs to return by a predetermined operation such as tapping the button BUD. Further, after checking that addition of a product is inappropriate as a result of checking according to the rechecking window WID shown in FIG. 18, the sales clerk instructs to return by a predetermined operation such as tapping the button BUE.

In accordance with the returning instruction as described above, the processor 401 of the cart terminal 400 determines that returning to product registration has been instructed in ACT422 in FIG. 9 (YES in ACT422), determines, determines that returning to product registration has been instructed in ACT426 (YES in ACT426), or determines that returning to product registration has been instructed in ACT430 (YES in ACT430). The processing of the processor 401 proceeds to ACT434. In ACT434, the processor 401 notifies the transaction processing apparatus 100 of that a returning instruction to product registration has been made.

In ACT435, the processor 401 finishes displaying the various pop-up screens. The processing of the processor 401 then returns to the stand-by state in ACT405 and ACT406 in FIG. 8. Note that in the case where the sales clerk checks that addition of a product is inappropriate as a result of checking according to the rechecking window WID shown in FIG. 18, he/she operates the cart terminal 400 such that the erroneous registration of a transaction product is corrected.

In accordance with the above notification of a returning instruction, the processor 101 of the transaction processing apparatus determines that returning to product registration has been instructed in ACT124 in FIG. 11 (YES in ACT124), determines that returning to product registration has been instructed in ACT127 (YES in ACT127), or determines that returning to product registration has been instructed in ACT130 (YES in ACT130). The processing of the processor 101 returns to the stand-by state in ACT103 and ACT104 in FIG. 10. Note that in the case where the checking flag set in the field FBD of the transaction data DAA is not “Checking necessary”, for example, in the checking in ACT121, the processor 101 determines that checking is unnecessary (NO in ACT121). The processing of the processor 101 skips ACT122 to ACT130 and proceeds to ACT131. In this case, since the transaction processing apparatus 100 instructs to display an accounting screen in response to the request for accounting in ACT411 in FIG. 8, the processor 401 of the cart terminal 400 displays an accounting screen on the touch panel 404 in ACT412. In ACT413, the processor 401 determines that the pop-up window (see ACT412) is not the checking informing window WIB (see FIG. 16) (NO in ACT413). The processing of the processor 401 proceeds to ACT433 in FIG. 9.

As described above, in the case where a product that needs to be checked because it can be included in a packaged bundle has been registered as a transaction product, the transaction processing apparatus 100 acquires, from the cart terminal 400, a camera image of the inside of the shopping basket SB. The transaction processing apparatus 100 displays the acquired camera image on the attendant terminal 300 as the instant checking window WIA shown in FIG. 15. In this way, a sales clerk can immediately check, on the basis of the display on the attendant terminal 300, whether or not a single-item product registered as a transaction product has been appropriately added to the shopping basket SB, i.e., whether a single-item product is erroneously registered as a transaction product when registering a packaged bundle as a transaction product. As a result, in the case where a single-item product has been specified as a transaction product when registering a packaged bundle as a transaction product, it is possible to immediately take measures to correct the erroneous specification.

Further, the transaction processing apparatus 100 detects addition of a product to the shopping basket SB, acquires, after the product that needs to be checked is registered as a transaction product, a camera image when addition of a product was detected, and displays the acquired camera image on the attendant terminal 300. In this way, it is possible to display, on the attendant terminal 300, a camera image of the inside of the shopping basket SB in which a product that needs to be checked or a packaged bundle including the product is added.

Further, the transaction processing apparatus 100 accepts specification regarding that addition of a product is appropriate in the instant checking window WIA shown in FIG. 15. In the case where a customer attempts to proceed to accounting without this specification made, the transaction processing apparatus 100 informs the customer of rechecking by a sales clerk. In this way, it is possible to reduce the risk that inappropriate addition of a product is not addressed in the case where sufficient checking cannot be performed with the instant checking window WIA.

Further, the transaction processing apparatus 100 does not allow payment unless the above rechecking is completed. This prevents payment from being made with an inappropriate product registration status.

Further, the transaction processing apparatus 100 displays a screen for prompting a sales clerk to check whether a packaged bundle is added to the container, as in the instant checking window WIA. This makes the sales clerk easily understand that the display of a camera image on the attendant terminal 300 is for checking whether a packaged bundle is added, and makes it possible to appropriately support the checking work.

In this embodiment, various modifications can be made as follows. Addition of a product to the shopping basket SB may be detected by, for example, image processing on a camera image or by another sensor such as an infrared sensor. Note that in the case of image processing, detection of product addition may be realized by processing of the processor 101 in the transaction processing apparatus 100 or processing of the processor 301 in the attendant terminal 300.

The imaging timing of a camera image to be displayed on the instant checking window WIA may be determined independently of detection of addition of a product to the shopping basket SB. For example, a camera image taken at the timing at which a predetermined time elapsed from product registration or next product registration was made may be displayed on the instant checking window WIA.

In the above embodiment, assumption is made that a single-item product that can be included in a packaged bundle is regarded as a product that needs to be checked, by prompting for checking relating to the packaged bundle in the instant checking window WIA. However, what product is regarded as a product that needs to be checked may be changed as appropriate. Note that although it is favorable to adapt the content of checking guidance in the instant checking window WIA to what product is regarded as a product that needs to be checked, guidance to check a product that needs to be checked without showing specific content to be checked may be simply made or only a camera image may be displayed. It is conceivable that, for example, a product that there is a product having a similar package size and weight and a different unit price is regarded as a product that needs to be checked. For example, regarding rice, a plurality of products that appears to be the same size but has different unit prices is displayed side by side in some cases. In such a case, the above embodiment is applicable to perform checking when the barcode of displayed rice is scanned and another rice next to it is added to the shopping basket SB.

In the above embodiment, part of the processing executed by the transaction processing apparatus 100 may be performed by the accounting machine 200, the attendant terminal 300, or the cart terminal 400. For example, update of transaction data may be performed by the processor 401 of the cart terminal 400. For example, the processing of acquiring a camera image from the cart terminal 400 may be performed by the processor 301 of the attendant terminal 300. For example, the processing for displaying a camera image may be performed by the processor 301 of the attendant terminal 300. That is, the monitoring support system according to the embodiment can be realized by a single apparatus such as the transaction processing apparatus 100 or can be realized by cooperation of at least two of the transaction processing apparatus 100, the accounting machine 200, the attendant terminal 300, and the cart terminal 400.

In order to take a camera image, a different camera installed in the cart may be used instead of the camera 405 of the cart terminal 400. The transaction processing apparatus 100 may acquire a camera image from the different camera via the cart terminal 400 or acquire a camera image through direct communication via the communication network 2. In this case, as a registration terminal, a terminal apparatus such as a smartphone that a customer uses hand-held may be used instead of the cart terminal 400.

By causing each piece of product data to include a checking flag in the transaction data DAA, the processor 101 may update, in ACT108 in FIG. 10, the checking flag included in the product data added to the transaction data DAA immediately before in ACT105. In this way, in the case where a plurality of products that needs to be checked is registered as transaction products, it is possible to manage whether or not rechecking is necessary for each of the plurality of products that needs to be checked. The processor 101 causes, in ACT128 in FIG. 11, for example, the character string CSE to be displayed on the rechecking window WID that is an instruction target for display (see FIG. 18) to represent only information regarding a product relating to product data including a checking flag in the state representing “Checking necessary”. In this way, it is possible to omit rechecking of a product that has been checked to be appropriate with the instant checking window WIA and save the labor of a sales clerk.

Part or all of each function realized by the processors 101, 301, and 401 through information processing can be realized by hardware that executes information processing that is not based on a program, such as a logic circuit. Further, each of the functions can also be realized by combining software control with the hardware such as a logic circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A monitoring support system, comprising:
a registration terminal that accepts specification of a product by a customer's operation and registers the specified product as a transaction product;
a camera that images an inside of the container that houses the product that is registered by the registration terminal;
a management terminal that displays the image taken by the camera; and
a processor configured to
determine whether or not the specified product accepted by the registration terminal is a predetermined product that needs to be checked;
acquire, where the specified product is the predetermined product that needs to be checked, the image taken by the camera at predetermined timing relative to timing at which the product that needs to be checked was registered as the transaction product by the registration terminal, and
display the acquired image on the management terminal.

2. The monitoring support system according to claim 1, wherein
the management terminal includes a touch panel that displays an instant checking window, the instant checking window being a window for displaying the acquired image and a character string for specifying whether or not the product that needs to be checked is appropriately added to the container, and
the processor is further configured to receive, from the management terminal, a result of specification of whether or not the product that needs to be checked is appropriately added to the container.

3. The monitoring support system according to claim 1, wherein
the processor is further configured to detect addition of a product to the container.

4. The monitoring support system according to claim 3, wherein
the processor is further configured to acquire an image taken by the camera at timing at which the addition of a product to the container was first detected after timing at which the product that needs to be checked was registered as the transaction product.

5. The monitoring support system according to claim 1, wherein
the registration terminal includes a touch panel that displays a rechecking window in accordance with an instruction from the processor, the rechecking window displaying a text message for informing a sales clerk of a store of checking of whether or not the product that needs to be checked is appropriately added to the container and a button for specifying that the product that needs to be checked is appropriately added to the container.

6. The monitoring support system according to claim 5, wherein
the management terminal includes a touch panel that displays an instant checking window, the instant checking window being a window for displaying the acquired image and a character string for specifying whether or not the product that needs to be checked is appropriately added to the container, and
the processor is further configured to
receive, from the management terminal, a result of specification of whether or not the product that needs to be checked is appropriately added to the container, and
display, where a result of specification that the product that needs to be checked is appropriately added to the container is not received from the management terminal, the rechecking window on the registration terminal.

7. The monitoring support system according to claim 5, wherein
the registration terminal includes a touch panel that displays a registration screen for registering the specified product as the transaction product, the registration screen displaying a button for specifying payment of the registered transaction product, and
the processor is further configured to display, where the registration terminal accepts specification of payment of the transaction product, the rechecking window on the registration terminal.

8. The monitoring support system according to claim 7, wherein
the processor is further configured to refrain from the payment until the registration terminal accepts specification that the product that needs to be checked is appropriately added to the container.

9. The monitoring support system according to claim 7, wherein
the touch panel of the registration terminal displays a checking informing window, the checking informing window being a window for informing a customer of that checking by a sales clerk is necessary, and
the processor is further configured to
display, where the registration terminal accepts specification of payment of the transaction product, the checking informing window on the registration terminal, and
display the rechecking window on the registration terminal after displaying the checking informing window on the registration terminal.

10. An information processing method for a monitoring support system including a registration terminal that accepts specification of a product by a customer's operation and registers the specified product as a transaction product, a camera that images an inside of the container that houses the product that is registered by the registration terminal, and a management terminal that displays the image taken by the camera, comprising:
determining whether or not the specified product accepted by the registration terminal is a predetermined product that needs to be checked;
acquiring, where the specified product is the predetermined product that needs to be checked, the image taken by the camera at predetermined timing relative to timing at which the product that needs to be checked was registered as the transaction product by the registration terminal; and
displaying the acquired image on the management terminal.
